(19) United States
(12) Patent Application Publication
(10) Pub. No.: US 2005/0048329 A1
(43) Pub. Date: Mar. 3, 2005

(54) Layered structure of Cu-containing superconductor and Ag or Ag alloys with Cu

(75) Inventors: Ruxandra Baurceanu, Chicago, IL (US); Thomas Wiencek, Orland Park, IL (US); Stephen E. Dorris, LaGrange Park, IL (US); Uthamalingam Balachandran, Hinsdale, IL (US); Beihai Ma, Naperville, IL (US)

Correspondence Address: Harry M. Levy;Emrich and Dithmar, Suite 3000, 300 South Wacker Drive, Chicago, IL, 60606, US

(73) Assignee: The University of Chicago, Chicago, IL (US)

(21) Appl. No.: 10/648,052

(22) Filed: Aug. 26, 2003

(51) Int. Cl. B32B 9/00

(52) U.S. Cl. 428/702

(57) ABSTRACT

A layered composition of a Cu-containing ceramic superconductor layer and a Ag-containing layer having between about 0.1 and about 0.3 atom percent Cu. The ceramic superconductor may be in contact with the Ag-containing copper doped layer which may be one or more of a substrate, a stabilizer or a sheath. Oxide superconductors are preferred.

### CONTRACTUAL ORIGIN OF THE INVENTION

The United States Government has rights in this invention pursuant to Contract No. W-31-109-ENG-38 between the U.S. Department of Energy (DOE) and The University of Chicago representing Argonne National Laboratory.

### FIELD OF THE INVENTION

The present invention relates to a new composition of matter involving a layered composition which includes a copper containing oxide ceramic superconductor in contact with a silver or silver alloy layer, the silver or silver alloy layer whether a substrate or a stabilizer or a sheath or any combination thereof having a small amount of copper thereon if in contact with the oxide superconductor.

### BACKGROUND OF THE INVENTION

High temperature ceramic oxide superconductors are of significant interest specifically, YBCO-coated conductors are the focus of intensive research efforts around the word because their critical current densities are high and relatively resistant to the effect of external magnetic fields. If YBCO-coated conductors become a commercial reality, it is likely that silver will be present in direct contact with the YBCO, either as a stabilizer that protects the conductor during quenches or as a substrate on which YBCO is grown. Silver is a likely component of coated-conductors, because it is chemically compatible with YBCO, even during processing at elevated temperatures, and its thermal and electrical conductivity are both high, important attributes for a potential stabilizer.

In an earlier application entitled “Fabrication of High Temperature Superconductors” filed Jul. 13, 2001, Ser. No. 09/905,509, now U.S. Pat. No. 6,579,360 issued on Jun. 17, 2003, the entire description of which is herein incorporated by reference, there were disclosed various methods by which YBCO as well as other Cu-containing ceramic superconductors could be grown on silver or silver alloy substrates. More recent experiments showed that YBCO films grown on silver were slightly deficient in copper, suggesting that copper had diffused into the substrate during YBCO deposition. In an effort to reduce the driving force for copper diffusion, a number of silver-copper alloys were examined as potential substrates for YBCO deposition. It was discovered that the properties of the YBCO films were significantly influenced by small concentrations of copper in the substrate and that silver substrates with a copper content of −0.20 at. % gave the best superconducting properties for YBCO films.

### SUMMARY OF THE INVENTION

Accordingly, it is an object of the present invention to provide an improved layered material in which an oxide superconductor containing copper is in direct contact with a silver or a silver alloy having copper present sufficient to prevent diffusion of copper from the ceramic superconductor which diminishes the superconducting properties thereof.

Another object of the present invention is to provide a substrate or a stabilizer or sheath for a copper containing oxide superconductor wherein the substrate or the stabilizer or sheath has sufficient copper content to prevent the superconductor from becoming copper deficient.

Yet another object of the invention is to provide a biaxially aligned superconductor deposited on a substrate of a biaxially or non-biaxially textured silver or silver alloy having copper present in an amount of from about 0.1 to about 0.3 atom percent.

Still another object of the present invention is to provide a layered composition of a Cu-containing ceramic superconductor layer and a Ag-containing layer having between about 0.1 and about 0.3 atom percent Cu.

The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

### BRIEF DESCRIPTION OF THE DRAWINGS

FIG. 1 is a schematic representation of a layered composition illustrating the various parts of the present invention;

FIG. 2 is a schematic representation of another embodiment of the present invention;

FIG. 3 is a graphical representation of the superconducting transitions of YBCO films deposited directly on silver substrates with various copper contents showing the relationship between the T_{c} onset and width of the superconductor transition (delta-T_{c}) copper content in the silver substrate; and

FIG. 4 is a graphical illustration of the variation of the drive current and texture factor in YBCO films with varying copper content in a silver substrate.

### DETAILED DESCRIPTION OF THE PREFERRED EMBODIMENT

Although the superconducting material described herein was deposited on the silver or silver alloy by pulse laser deposition, other methods such as those described in the above-referenced application are applicable as well as others not previously described. For instance, metal organic vapor deposition (MOCVD) or those well known in the art are viable methods. Various other methods such as the RABiTS, IBAD and ISD methods may be used to form the substrates for depositing superconductor material thereon.

Although the superconductor used to describe the subject invention is a YBCO superconductor, any copper containing ceramic superconductor may be incorporated as a layer into the present invention. More particularly, a variety of superconducting materials may be used as a source of oxide atoms or ions. For example, there may be included elements, salts, or oxides of copper, yttrium and barium for the YBCO family of oxide superconductors. Elements or oxides of copper, bismuth, strontium and calcium and optionally lead for the BSCCO family of oxide superconductors; element salts or oxides of copper, thallium, calcium, and barium or strontium, and optionally bismuth and lead for the thallium (TBSCCO) family of oxide superconductors; elements, salts or oxides of copper, mercury, calcium, barium or strontium, or optionally bismuth and lead, for the mercury (HBSCCO) family of oxide superconductors are all possible alternatives to the hereinafter discussed wide family of oxide superconductors. Moreover, the YBCO family of oxide superconductors is considered to include all oxide superconductors of the type comprising barium, copper and a rare earth selected from the group consisting of yttrium, lanthanum, neodymium, samarium, europium, gadolinium, terbium, dysprosium, holmium, erbium, thulium, ytterbium, and lutetium. The formation of an intermediate may be desired in order to take advantage of desirable processing properties. It is intended to cover herein precursors in amounts sufficient to form any biaxially aligned (textured) superconductor. In some embodiments, the precursor powders may be provided in substantially stoichiometric portions. In others, there may be a stoichiometric excess or deficiency of any precursor to accommodate the processing conditions used to form the desired superconducting composite. The invention also includes doping with various elements such as calcium and the term “superconductor” is intended to cover precursors along with dopant quantities of other materials.

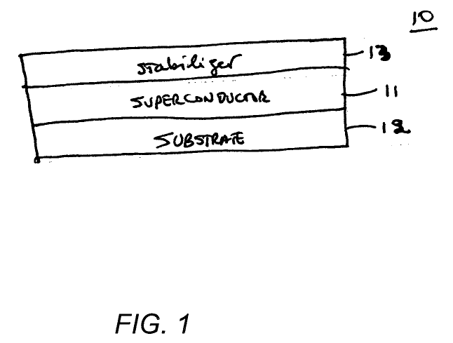

Referring now to FIG. 1 of the drawings, there is shown a layered composition 10 in which a copper containing ceramic superconductor 11 is in direct contact with the substrate 12 and a stabilizer 13. As before stated, the superconductor 11 may be any of the copper containing ceramic superconductors previously described. The substrate may or may not be a silver or silver alloy material containing copper in the range of from about 0.1 to about 0.3 atom percent. The stabilizer may or may not be a silver or silver alloy containing copper in the range of from about 0.1 to 0.3 atom percent. The invention extends to any layered material in which a superconductor of the type hereinbefore described is in direct contact with a silver material, whether it is in the form of a silver or silver alloy or whether it is used as a substrate, whether a biaxially aligned or non biaxially aligned substrate or as illustrated in FIG. 1, a three layer composition. In many instances, silver or a silver alloy will be used as a stabilizer in case of a superconducting failure. Again, when silver or a silver alloy is in contact with a copper containing ceramic superconductor, it has been found that the copper diffuses into the silver or silver alloy. When this occurs, the copper containing ceramic superconductor becomes deficient in copper and the superconducting properties thereof diminish significantly.

Although copper in the range of from about 0.1 to about 0.3 atom percent has been found to be effective in preventing the diffusion of copper from a ceramic superconductor into a silver or silver alloy layer, it has been found that silver or silver alloy layers having a copper content of about 0.2 atom percent give the best superconducting properties for the copper oxide ceramic superconductors.

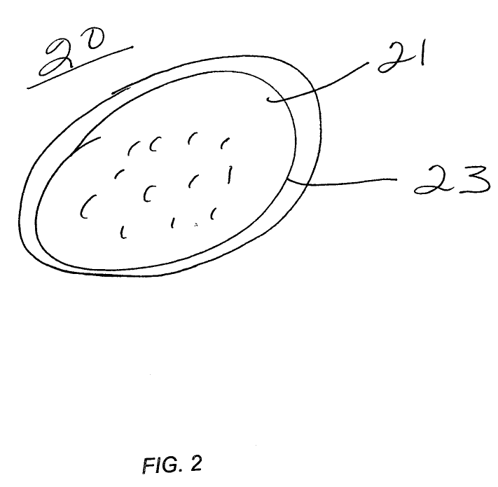

Referring to FIG. 2, there is shown another embodiment 20 of the present invention comprising a superconductor 21, and a sheath 23 surrounding the superconductor 21. The materials previously described with respect to the layered composition 10 pertain to the embodiment 20.

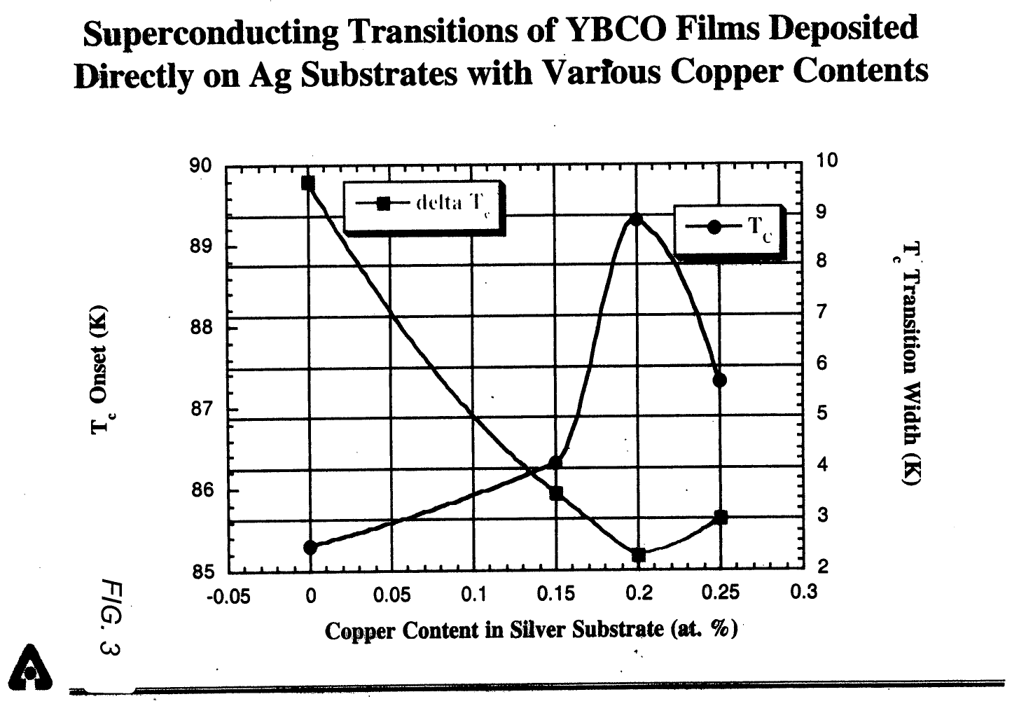

Referring now to FIG. 3, there is disclosed the relationships between the T_{c} onset in ° K, the T_{c} transition width in ° K as a function of the copper content in a silver substrate for YBCO film deposited directly on silver substrates in accordance with the pulsed laser deposition technique described in the previously mentioned patent (issued patent). The pulsed laser deposition was accomplished with a 248 nm krf exciter laser, Tₛ=780° C. (Tₛ is substrate temperate). The superconducting properties of the deposited YBCO layer were measured by inductive and transport methods and the structural characterization was performed using a Raman, XRD and SEMs. When adding copper to silver to provide the various copper concentrations of 0.15, 0.20 and 0.25 atom percent, the silver had originally approximately 9 ppm copper which translates to 1 ten thousand of a weight percent of copper in the silver prior to the addition thereof of the copper as illustrated.

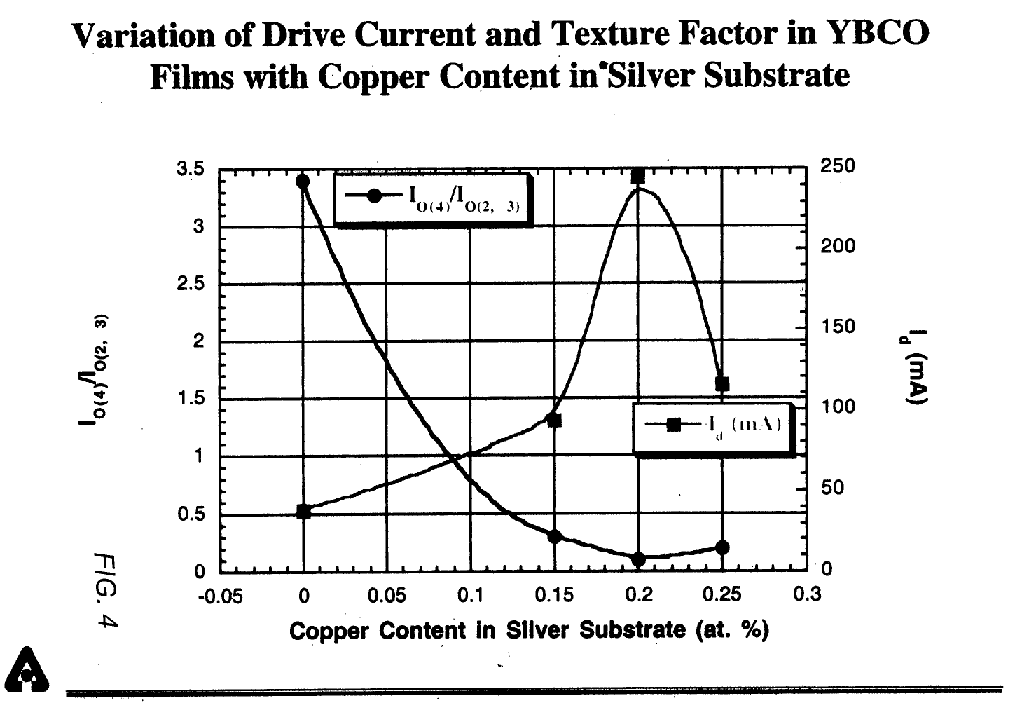

As seen from the accompanying FIGS. 3 and 4, YBCO films deposited on silver alloy with copper were characterized by significantly fewer a-axes out growths and better superconducting properties with higher T_{c} with a sharper transition and higher J_{c} than those YBCO films fabricated on pure silver.

As before stated, although this invention has been described with respect to silver layer having copper present in the range of from about 0.1 to about 0.3 atom percent, various silver alloys are suitable to act as either a substrate or a stabilizer or both. Although the YBCO family of superconductors was used to describe the present invention, the other superconductors hereinbefore described are within the ambient of the present invention and are intended to be covered by the invention.

While particular embodiments of the present invention have been shown and described, it will be appreciated by those skilled in the art that changes, modifications and improvements may be made, for example in the processing of the materials without departing from the true spirit and scope of the invention.

1. A layered composition of a Cu-containing ceramic superconductor layer and a Ag-containing layer having between about 0.1 and about 0.3 atom percent Cu.

2. The layered composition of claim 1, wherein the Cu-containing ceramic superconductor is a member of the YBCO family.

3. The layered composition of claim 1, wherein the Cu-containing ceramic superconductor is a member of the BSCCO family.

4. The layered composition of claim 1, wherein the Cu-containing ceramic superconductor is a member of the TBSCCO family.

5. The layered composition of claim 1, wherein the Cu-containing ceramic superconductor is a member of the HBSCCO family.

6. The layered composition of claim 1, wherein the Ag-containing layer is a substrate.

7. The layered composition of claim 1, wherein the Ag-containing layer is a biaxially aligned or a non-biaxially aligned substrate.

8. The layered composition of claim 1, wherein the Ag-containing layer is a stabilizer.

9. The layered composition of claim 1, wherein the Ag-containing layer is a sheath.

10. The layered composition of claim 1, wherein the Ag-containing layer has about 0.2 atom percent Cu.

11. The layered composition of claim 1, wherein the Ag-containing layer is in direct contact with at least a portion of the Cu-containing ceramic superconductor.

12. The layered composition of claim 1, wherein the Ag-containing layer is present as both a substrate and as a stabilizer.

13. The layered composition of claim 1, wherein the Ag-containing layer is present as both a substrate layer and a stabilizing layer, both layers being in direct contact with at least a portion of the Cu-containing ceramic superconductor.

14. The layered composition of claim 1, wherein the Ag-containing layer is present as one or more of the substrate and the stabilizing layer and the sheath.

15. A biaxially or a non-biaxially aligned Ag or Ag alloy substrate layer having between about 0.1 and about 0.3 atom percent Cu directly in contact with a Cu-containing ceramic superconductor.

16. The composition of claim 15, wherein the Cu-containing superconductor is a member of one or more of the YBCO family or the BSCCO family or the TBSCCO family or the HBSCCO family.

17. The composition of claim 16, wherein a Ag or Ag alloy layer having between about 0.1 and about 0.3 atom percent Cu is a stabilizing layer and/or a sheath in contact with the Cu-containing ceramic superconductor.

18. The composition of claim 17, wherein the Cu-containing ceramic superconductor is a member of the YBCO family.

19. The composition of claim 18, wherein the Cu is present in the Ag or Ag alloy at about 0.2 atom percent.

20. The composition of claim 19 made by the method of forming a biaxially aligned superconductor on a non-biaxially aligned substrate substantially chemically inert to the biaxially aligned superconductor comprising: providing a non-biaxially aligned substrate chemically inert to the superconductor, and depositing a biaxially aligned superconductor material directly on the non-biaxially aligned substrate.
